(19) United States
(12) Patent Application Publication
(10) Pub. No.: US 2025/0131093 A1
(43) Pub. Date: Apr. 24, 2025

(54) SYSTEM AND METHOD FOR SAAS DATA CONTROL PLATFORM

(71) Applicant: ROYAL BANK OF CANADA, Toronto (CA)

(72) Inventors: Salah SHARIEH, Toronto (CA); Fatima Javaid HUSSAIN, Toronto (CA); Evgenii OSTANIN, Toronto (CA); Brett NOYE, Toronto (CA); Paula DUZI, Toronto (CA); Haoyue BAI, Toronto (CA); Nebojsa DJOSIC, Toronto (CA)

(73) Assignee: ROYAL BANK OF CANADA, Toronto, ON, ON (CA)

(21) Appl. No.: 18/920,708

(22) Filed: Oct. 18, 2024

Related U.S. Application Data
(60) Provisional application No. 63/591,549, filed on Oct. 19, 2023.
(60) Provisional application No. 63/591,560, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.
(60) Provisional application No. 63/655,183, filed on Jun. 3, 2024.

(51) Int. Cl. G06F 21/57; G06F 16/31

(52) U.S. Cl. CPC G06F 21/57; G06F 16/322

(57) ABSTRACT

There is provided a method for monitoring and assessing compliance of a computing system. The method may include receiving documents containing rules. Each document may be converted to a tree structure having nodes. A mapping object may be generated to map a tree structure to another tree structure. A second mapping object may be generated to relate a tree structure to compliance controls. A third mapping object may be generated to relate compliance controls to a set of compliance control evidence. A compliance score may be determined based on the controls, the evidence, and the mappings.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655,183, filed Jun. 3, 2024, the entire contents of each of the above-identified applications being incorporated herein by reference.

### FIELD

This relates generally to computerized systems for use with Software-as-a-Service applications, and in particular to systems for determining compliance.

### BACKGROUND

The use of computerized systems and software has become ubiquitous throughout organizations. In many organizations, the use of third party Software-as-a-Service (SaaS) applications (i.e. SaaS applications which are created and administered outside of the organizing using the SaaS) is becoming increasingly common, as modern communications systems have overcome bandwidth limitations which might have limited the utility of such SaaS applications in the past. Moreover, an increasing number of vendors have shifted to only offering SaaS distribution models.

However, there are a number of challenges inherent with the use of third party SaaS applications for organizations. For example, an organization may be subject to regulations and/or compliance requirements to which the organization is required to adhere. When computer and/or software systems are developed and implemented within an organization, such systems may be tailored to the particular regulations and/or compliance requirements to which the organization is bound. However, third party SaaS applications may not have been developed with a particular set of regulations or compliance requirements in mind, particularly given that compliance requirements might vary from customer to customer, and as such there might not be a uniform set of standards for to which a particular SaaS application must adhere.

For many organizations, adherence to regulatory and compliance requirements is of paramount importance, and ensuring that any proposed new SaaS is compliant with regulations and/or compliance requirements may be a time-consuming and onerous task, which may prevent, impede or retard the adoption of improved technologies and services. Moreover, ensuring that an existing SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

Accordingly, there is a need for a computing system which facilitate the automated and continuous compliance monitoring of applications, while ensuring that growing numbers of applications and compliance requirements can be managed in an automated and reliable manner.

### SUMMARY

According to an aspect, there is provided a method for monitoring compliance of a computing system, the method comprising: receiving a plurality of documents containing rules; converting each of said plurality of documents to a respective tree structure comprising a plurality of nodes; generating a tree mapping relating a first one of said respective tree structures to a second one of said respective tree structures; generating a control mapping relating said first one of said respective tree structures to a set of one or more compliance controls; generating an evidence mapping relating said set of one or more compliance controls to a set of compliance control evidence; and determining a compliance score for an entity based on said compliance controls, said compliance control evidence, and said evidence mapping.

According to another aspect, there is provided a system for monitoring compliance of a computing system, the system comprising: one or more processors; and a non-transitory computer-readable storage medium having stored thereon processor-executable instructions that, when executed by said one or more processors, cause the one or more processors to perform a method comprising: receiving a plurality of documents containing rules; converting each of said plurality of documents to a respective tree structure comprising a plurality of nodes; generating a tree mapping relating a first one of said respective tree structures to a second one of said respective tree structures; generating a control mapping relating said first one of said tree structures to a set of one or more compliance controls; generating an evidence mapping relating said set of one or more compliance controls to a set of compliance control evidence; and determining a compliance score for an entity based on said compliance controls, said compliance control evidence, and said evidence mapping.

According to still another aspect, there is provided a non-transitory computer-readable storage medium having stored thereon processor executable instructions that, when executed by one or more processors, cause the one or more processors to perform a method comprising: receiving a plurality of documents containing rules; converting each of said plurality of documents to a respective tree structure comprising a plurality of nodes; generating a tree mapping relating a first one of said respective tree structures to a second one of said respective tree structures; generating a control mapping relating said first one of said respective tree structures to a set of one or more compliance controls; generating an evidence mapping relating said set of one or more compliance controls to a set of compliance control evidence; and determining a compliance score for an entity based on said compliance controls, said compliance control evidence, and said evidence mapping.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at a computing device;

FIG. 4 is a block diagram depicting example components of a compliance mapping system;

FIG. 5 is a block diagram depicting a simplified compliance mapping system;

FIGS. 6A and 6B are illustrations depicting the conversion of a regulatory or policy document to a tree structure;

FIG. 7 is a block diagram depicting the relation between documents, tree structures, mappings, controls, and evidence; and

FIG. 8 is an illustration of an example tree structure having nodes named in accordance with a semantic naming system.

### DETAILED DESCRIPTION

At present a given organization may use dozens or even hundreds of Software-as-a-Service (SaaS) solutions across various lines of business, and which have varying degrees of complexity (e.g. some may use confidential data, others may use sensitive data, still others may use restricted data, and the like). Such SaaS applications may be executing on different cloud platforms, although many SaaS applications may be concentrated within a few large cloud providers (e.g. Amazon Web Services, Microsoft Azure, Google Cloud Platform, and the like).

When an organization decides whether to make use of a new SaaS solution, an organization must determine whether the SaaS solution is compliant with regulatory and compliance requirements, and this may be difficult to determine in an expedient manner. In particular, there are many different approaches to assessing regulatory compliance and risk (e.g. Supplier Risk Management Assessments (SRMA), Shared SaaS Responsibility Assessments (SSRA), Supplier Controls Assessments (SCA), and the like), many of which are questionnaire-based and require inputs from both users and suppliers to make an assessment. Completion of such assessments can be quite time-consuming, which limits the ability for SaaS solutions to be adopted in a timely manner, and which may pose significant inconvenience internally within an organization.

As described herein, some embodiments may provide data-driven automation for SaaS applications which facilitates processing of compliance evidences and continuous real-time risk assessment. Some embodiments may facilitate automation of onboarding processes for SaaS applications to ensure that a SaaS application is compliant from the beginning, and/or to reduce the amount of time required to certify a SaaS application as compliant. Some embodiments may allow for automation of compliance assessments for SaaS applications which run on computing platforms which are external to an organization's network (e.g. SaaS applications running on public and/or third-party cloud computing platforms, such as Amazon Web Services (AWS)). In some embodiments, systems disclosed herein may facilitate identification of dependences and patterns which exist between a plurality of SaaS applications (e.g. dependencies which may exist between SaaS applications relating to customer relationship management, business process management, human resource management, and the like).

In some embodiments, systems and methods disclosed herein may allow for one or more of: SaaS applications being adopted and onboarded faster than traditional methods, resulting in reduction of the time required to implement a new SaaS application, a reduction in the cost of onboarding an SaaS application, a reduction in the costs associated with regulatory compliance for a given SaaS application, a reduction in the cost of governance and management associated with a given SaaS application, real-time access to risk and compliance data relating to an SaaS, more accurate risk and compliance data, the ability to demonstrate alignment/compliance with regulatory requirements, and/or the ability to more quickly recognize which SaaS applications require further attention and/or scrutiny.

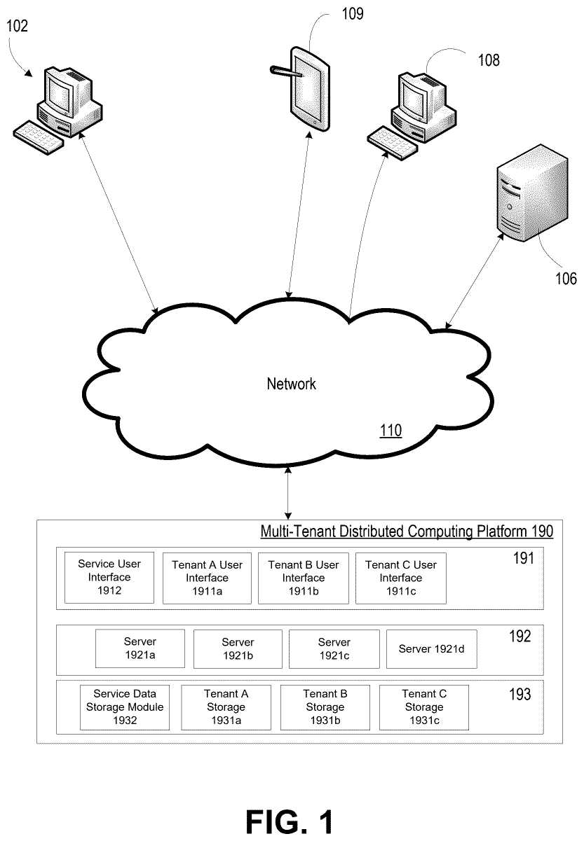

Various embodiments of the present invention may make use of interconnected computer networks and components. FIG. 1 is a block diagram depicting components of an example multi-tenant operating environment. Components of the computing system are interconnected to define a compliance and risk assessment system. As used herein, the term “compliance and risk assessment system” refers to a combination of hardware devices configured under control of software and interconnections between such devices and software. Such systems may be operated by one or more users or operated autonomously or semi-autonomously once initialized.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 104 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1.

Network 110 may include one or more local-area networks or wide-area networks, such as IPv4, IPV6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g. service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In the some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g. Amazon, Microsoft, Google, or the like) in order to provide multiple tenants with applications, data storage, and functionality. A multi-tenant system as depicted in FIG. 1 may include multiple different applications (e.g. multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

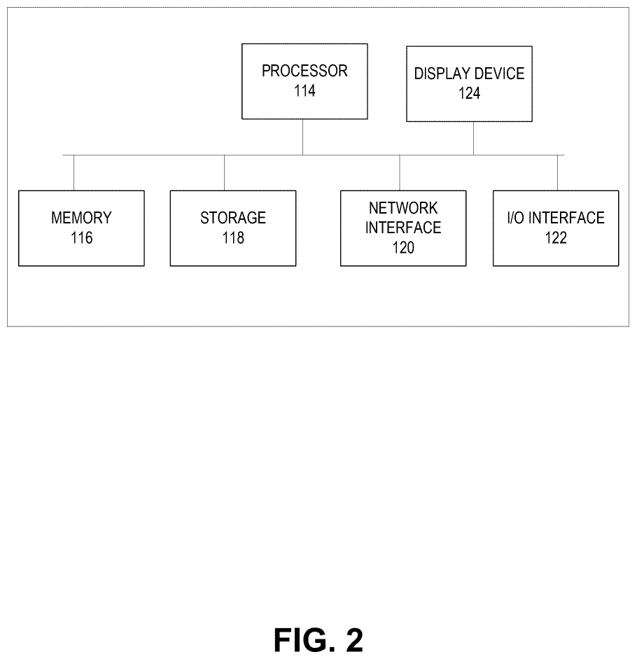

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third party SaaS applications (e.g. SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

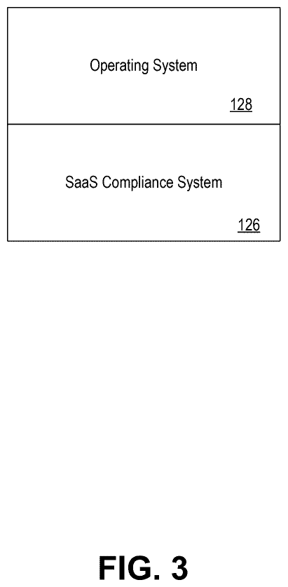

FIG. 3 depicts a simplified arrangement of software at an example computing device. The software may include an operating system 128 and application software, such as SaaS compliance system 126. It will be appreciated that in distributed computing environments, implementation and administration of an application such as a SaaS application or a SaaS compliance system 126 may be distributed amongst a plurality of separate computing devices, and FIG. 3 is intended to depict a simplified logical separation between an operating system and an application executing thereon on an example computing device.

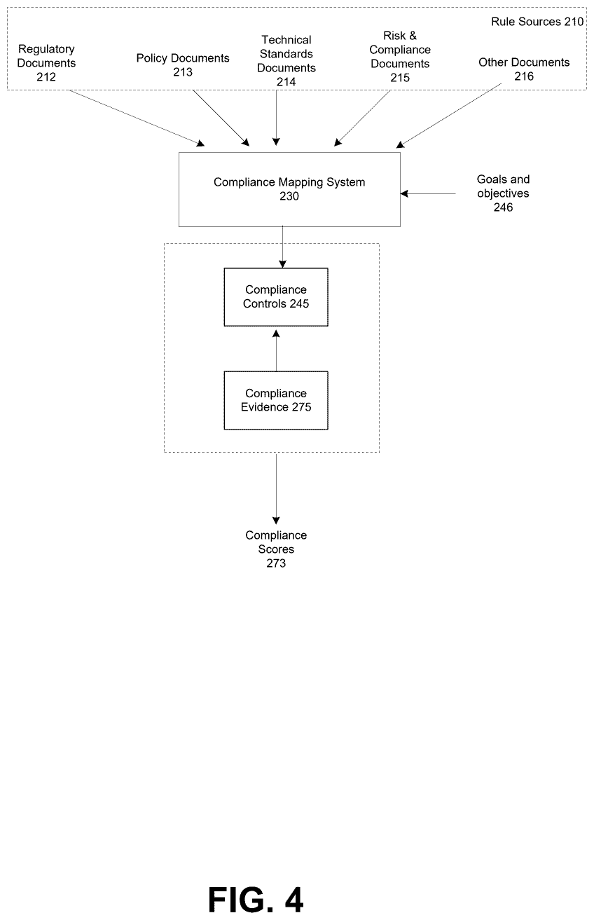

FIG. 4 is a block diagram chart depicting example components of a compliance system 126, in accordance with some embodiments. As depicted, system 126 includes rules sources 210. In some embodiments, rules sources 210 may include, but are not limited to, regulatory documents 212, policy documents 213, technical standards documents 214, risk and compliance documents 215, and other documents 216. As such, rules sources 210 may include documents which are created at one or more of the industry, government and/or regulator, corporate, as well as team levels.

Rules sources 210 can be conceptualized generally as unstructured texts which contain a variety of rules and constraints. Moreover, different rules sources (e.g. technical standards documents vs. regulatory documents) are typically created by teams of experts within distinct domains and may not use similar terminology. Although rules sources 210 may contain numerous interrelated or overlapping rules and regulations which an organization may be required to follow, the contents of such rules sources 210 is not easily read or understood by a computing device, and relationships and/or commonalities between such documents would not be apparent or ascertainable. As such, the process of determining whether a particular SaaS product is compliant with all of the relevant requirements is particularly difficult and time-consuming.

Moreover, in the event that relationships between rules sources 210 are determined (e.g. by a team of experts from disparate domains), such relationships may only be true as long as each of the relevant rules sources 210 remain unchanged. It is possible that an amendment to one rules source 210 (e.g. an amendment to a regulatory document 212 or technical standards document 214) may result in all of the previously identified interrelationships being rendered invalid, and as such may require continuous expenditure of effort from experts to verify.

Typically, combinations of such rules sources 210 is used as a source of requirements for an organization when implementing or considering implementation of a software application (e.g. a SaaS application). As such, determining whether that particular SaaS application is compliant with all of the relevant rules sources 210 is a significant and time-consuming undertaking, requiring the involvement of numerous subject matter experts each step of the way.

Moreover, applications currently available tend to require significant training for users in order to ensure compliance, as well as customized configurations which must be prepared, implemented, and tested prior to production deployment, which entails further pilot runs and migrations during production. The execution of an application will product evidence which may then be used to assess compliance with the relevant rules 210. Frequently, even minor changes to requirements may lead to significant complications and render the comparison of compliance evidence from before and after the change difficult, as data may become incompatible or inappropriate to compare.

In some embodiments, system 126 may allow for the additional, removal, and/or modification of rule sources 210 while maintaining a coherent mapping between compliance evidence obtained before and after such addition, removal and/or modification.

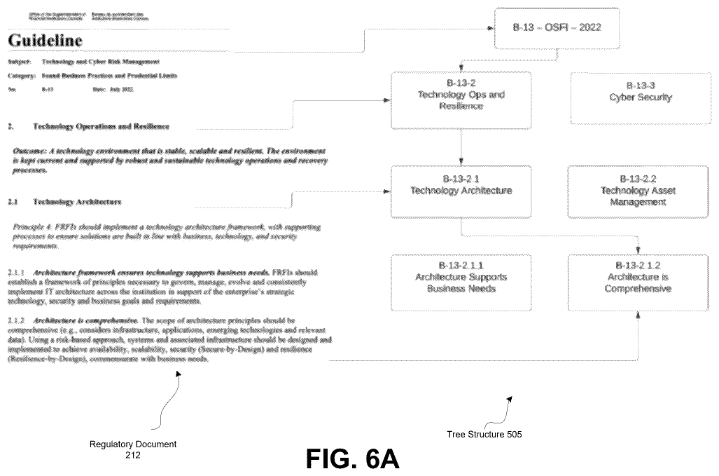

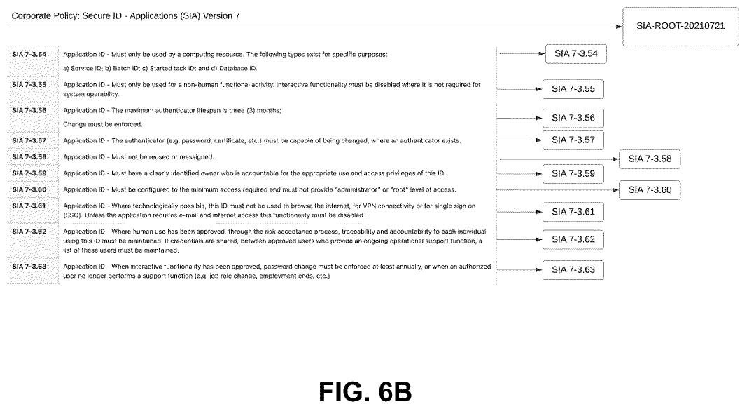

In some embodiments, system 126 may include a mapping and tree generation (MTG) module. In some embodiments, the MTG may process human-readable documents and convert such documents into formats suitable for automation and processing using computer hardware and software-based systems, such as tree structures 505 (as depicted, for example, in FIG. 6A).

In some embodiments, the regulatory tree structures 505 may be formatted in accordance with a specific structure which facilitates de-coupling and enables numerous unique and beneficial features as described below.

As depicted in FIG. 4, system 126 may include a Compliance Mapping System 230. Compliance mapping system 230 is a computer-based system for performing at least one of processing, organizing, and storing compliance, governance, policy, and technical standard documents. System 230 may be further configured to store compliance configuration data, compliance evidence data 275, and relationships therebetween.

In some embodiments, system 230 may facilitate continuous, automated, real-time processing of evidence 275, the conducting of compliance assessments, and reporting the alignment of an application to regulatory policies (e.g. calculating a compliance score 273). In some embodiments, system 230 may be configured to optimize and recalculate various compliance and risk assessment scores at various aggregation levels. In some embodiments, system 230 may be configured to display, on a user interface, a visualization (e.g. a heat map) of areas of vulnerability or otherwise requiring attention of some kind.

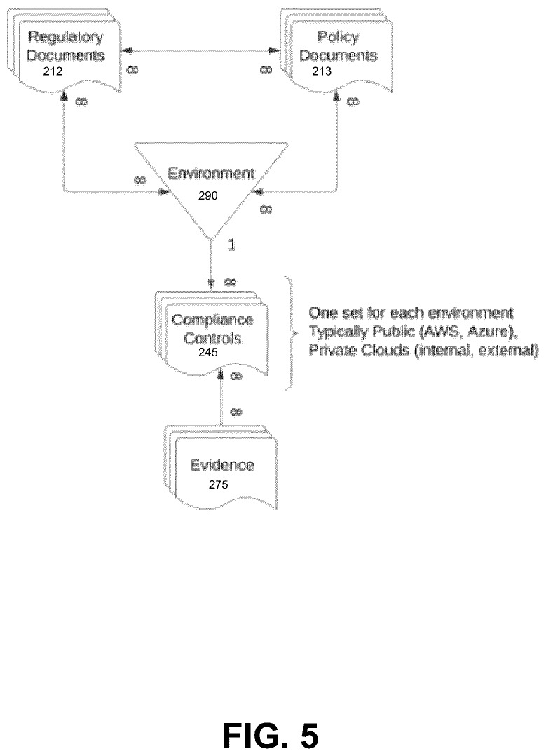

System 230 may be further configured to calculate compliance scores 273 for individual applications (e.g. SaaS applications), as well as for different subgroups within an organization (e.g. business units, or groups which all share a common cloud 290 provider (e.g. AWS, Google, Microsoft)), as well as compliance scores 273 for different application types. As depicted in FIG. 5, in some embodiments, a different set of compliance controls 245 may be in place for each operating environment 290 (whether a public or private cloud provider).

In some embodiments, system 230 includes a plurality of categories of data, including a) governance, compliance, policy, and other documents (e.g. rule sources 210), b) compliance controls 245 and compliance evidence 275, c) intermediary objects and mappings 620, and d) assessment goals 246 and optimization configurations. In some embodiments, controls 245 are tools which define requirements that can be used to collect compliance evidence 275. In some embodiments, compliance evidence 275 may be collected automatically and/or continuously.

In some embodiments, system 230 is configured to accept a wide range rule sources 210, including governance, compliance 215, policy 213 and standards 214 frameworks, as well as other external or internal regulatory documents 216. System 230 is configured to process, organize, and store the aforementioned sources 210.

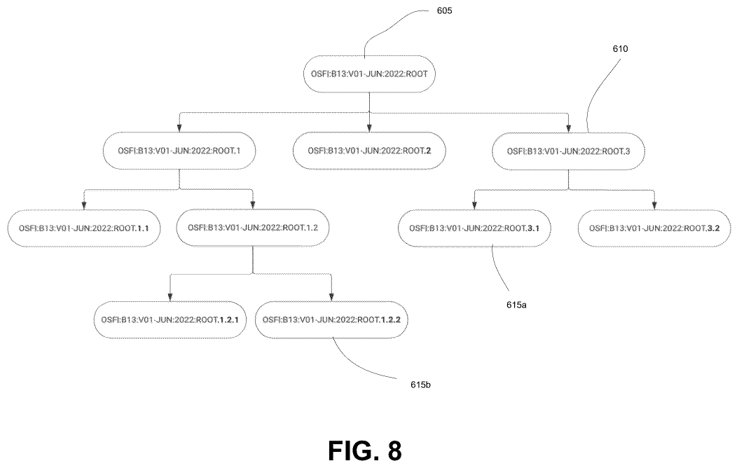

In some embodiments, system 230 is configured to represent sources 210 as respective regulatory trees 505 together with mappings 620 representing relationships between different regulatory trees. FIGS. 6A and 6B provide examples of mappings from regulatory documents and policy documents 212, 213 to tree structures 505. As depicted in FIG. 8, regulatory trees are hierarchical data structures in which there is a single root node 605 that has one or more child nodes 610, such that every node has one and only one parent node (aside from the root node 605, which has no parent). Nodes without any children are referred to as leaf nodes 615.

In some embodiments, every node in tree 505 is assigned a unique semantic identification string (as depicted, for example, in FIG. 8). The unique semantic identification tree may fully and intuitively define the position of the node within the tree 505 relative to the root node 605. In some embodiments, the root node 605 identification string may uniquely identify the particular tree 505 from among a larger set of regulatory trees, and across all sets of regulatory trees. In some embodiments, the identification string may include data indicating a version. The inclusion of a version identifier may ensure the uniqueness of each node, tree, and grouping of trees across the entire system.

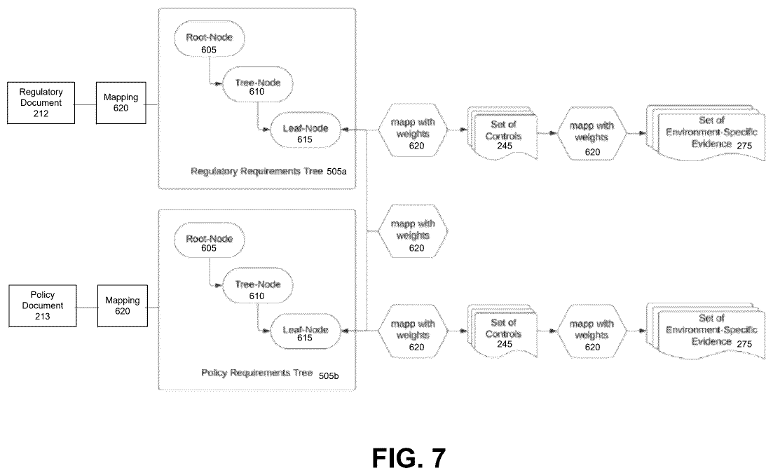

As depicted in FIG. 7, each tree 505a, 505b may be associated with one or more intermediary mapping objects 620. In some embodiments, a regulatory tree 505 might not be associated with any intermediary mapping objects 620. In embodiments in which a particular regulatory tree 505 is not associated with any intermediary mapping objects, that particular regulatory tree 505 will not participate in any assessment or processing of compliance evidence (since there is no way of associating regulations with compliance evidence without any intermediary mappings). Such regulatory trees 505 are referred to herein as “dormant” regulatory trees. In some embodiments, a dormant regulatory tree may become active (e.g. by becoming associated with one or more intermediary mapping objects). In some embodiments, an active regulatory tree may become dormant (e.g. if newly created, a new version of an existing tree, or an old version of a tree which is no longer in use).

In some embodiments, regulatory trees 505a, 505b are associated with compliance controls 245 by way of weighted intermediary objects and mappings 620. In some embodiments, intermediary objects may include attributes such as system stakeholder configurations, performance targets, business objectives, and the like. Such attributes may be expressed as biases and weights, error tolerances, trash-holds, and the like, as described in further detail below.

As depicted in FIG. 4, to assess whether (or the degree to which) an application is compliant with regulatory, governance, policies, and/or standards, system 230 uses compliance controls 245 and compliance evidence 275.

In some embodiments, compliance controls 245 are generic, independent measurable metrics and/or indicators which can be used to track and/or monitor the degree of conformity/alignment of an application to policies and standards, as well as to regulatory and governance requirements. In some embodiments, compliance controls 245 may be generic, application agnostic, and environment agnostic. Therefore, compliance controls 245 may be reused across multiple documents 210. An example control may be “the system must use, at minimum, TLS version 1.2”. As will be appreciated, this control 245 is not specific to a particular application, environment or system.

In some embodiments, compliance controls 245 are used for assessing compliance in conjunction with compliance evidence 275. In some embodiments, compliance evidence 275 is environment-specific. In some embodiments, compliance evidence is application-specific. Compliance evidence 275 may include raw data collected at run-time about and from a particular application. In some embodiments, compliance 275 may be the result of a rule evaluation. For example, in relation to the example control 245 relating to a minimum TLS version above, an example of compliance evidence 275 would be a value of “true” or “false” as an evaluation of the statement “TLS version is greater or equal than 1.2”.

In some embodiments, system 230 is configured to receive a continuous feed or stream in real-time of compliance evidence 275 data and/or events from applications (e.g. SaaS applications such as Gmail or WebEx). In some embodiments, compliance evidence data 275 may be attributed to a specific account within a particular application that is uniquely identifiable. In accordance with some embodiments of the present invention, this compliance evidence data 275 may be linked to controls 245 which are in turn linked to policies and/or regulatory requirements (or more generally, rules with which system 126 is required to comply). By linking compliance evidence data 275 to compliance controls 245, system 230 enables ongoing running assessments, risk and compliance score calculations, and the demonstration of compliance with regulatory, policy and standards requirements.

As noted above, in some embodiments, compliance controls 245 may be associated with compliance regulatory trees 505, and compliance evidence data 275 is associated with compliance controls 245 via weighted intermediary objects and mappings which define relationship paths. In some embodiments, relationship paths may be modeled as graphs. Intermediary objects and mappings may provide a link between graphs and trees 505. In some embodiments, intermediary objects and mappings may provide additional context information for the relationship (e.g. through the use of weights), which may allow for automated processing.

In some embodiments, a special storage configuration may be used for storing intermediary mapping objects 620. Reverse indexing may be useful for indexing and accessing data which is organized in a sequential manner. In some embodiments, reverse indexing mapping objects 620 may enable lookups which start from a regulatory tree 505 and identify all compliance evidence 275 that participants in a particular assessment. As such, reverse indexing may be used to facilitate the quick creation of relationship graphs while allowing for continuous, automated, independent creation and maintenance of relationships defined in relationship graphs. Reverse indexing may further allow for a lookup which starts with specific evidence 275 collected, and can identify all regulatory trees 505 which that evidence will affect. The use of reverse indexing may facilitate the efficient constructing of processing graphs using lookups, and such processing graphs may be used to calculate compliance scores. In some embodiments, compliance scores may be calculated in parallel.

In some embodiments, compliance evidence 275, compliance controls 245, and compliance regulatory trees 505 (defined by various rule sources 210) may be interconnected by one or more many-to-many mappings (i.e. intermediary objects). Intermediary objects may describe and map relationships between different, independent objects (e.g. between policy documents and regulatory documents, or portions thereof). As another example, each leaf node 615 from a governance tree 505 may be linked or mapped to a set of compliance control objects 245 via an intermediary object. In some embodiments, a separate intermediary object may map each compliance control 245 to a set of evidence source controls capable of providing the requisite compliance evidence 275 for that control 245. Moreover, regulatory tree nodes 610 may be mapped to policy tree nodes through intermediary documents.

In some embodiments, all trees 505, intermediary objects, controls 245 and evidence 275 may be kept decoupled through the use of intermediary documents. This is possible at least in part because the unique semantic identification strings for each nodes allow for all entities to be uniquely identified and referenced. As such, automation throughout an entire system is possible. Moreover, since all trees, intermediary objects, controls 245 and evidence 275 may be kept decoupled, this may further enable continuous, independent, automated maintenance (e.g. updating) of all objects without compromising system functionality.

For example, as depicted in FIG. 7, a regulatory document 212 may be linked to a regulatory tree 505a by one or more intermediary mappings 620. That regulatory tree 505a may be linked to a compliance control 245 by a mapping 620. That compliance control 245 may be linked to environment-specific compliance evidence 275 by a mapping 620.

It should be appreciated that the use of intermediary mappings 620 allows for domain expertise to be bifurcated from technical expertise. For example, regulatory and compliance experts are typically involved in assessing, assigning weights, and mapping regulatory trees 505 and compliance controls 245, whereas IT architecture experts and application/cloud/platform-specific experts are typically involved in mapping compliance controls 245 and compliance evidence 275. Instead of these teams of experts having to intermingle, each team may be left to maintain their responsibilities as they normally would. In some embodiments, system 230 may handle the interrelationships due to the manner in which objects and relationships are modeled, stored, and organized to allow for flexibility without compromising performance.

Moreover, due to the decoupling and encapsulation of mappings 620, system 230 may allow for multiple optimization and classification configurations to be in operation. Since mappings 620 are decoupled, multiple mapping schemes are free to exist at the same time, and may be run in parallel without significantly impacting performance.

In some embodiments, the assessment of whether an application is in compliance may be achieved by assigning weights (as well as one or more of biases, error tolerances, trash-holds, and the like) to intermediary objects 620 (e.g. mappings). In some embodiments, weights allow for the computation of aggregated scores for each compliance control 245 and for some or each element of every regulatory tree 505 (aside from regulatory trees 505 which do not have any mappings 620 associated therewith).

Moreover, some embodiments employ multiple different weighting and mapping schemas, which provides users and stakeholders with multiple different assessments obtained from the same data. The ability to enable risk and compliance assessments from multiple different perspectives (i.e. using different weighting and mappings) may enhance the overall system 230's risk and compliance assessment capabilities. In addition, the de-coupling of system 230 may allow for groupings of applications to be created even after evidence 275 has already been collected (i.e. in real-time). For example, a user may define a new group (e.g. “the top 10 SaaS applications based on the number of users”) in real-time and the resulting risk and compliance scores may be recalculated by the system in real-time for that new grouping.

A practical reality of many industries is that regulatory requirements 212 and an organization's policies 213 tend to focus on security and privacy. The nature of security and privacy is that the landscape is constantly changing and evolving, and it is beneficial to have a multitude of perspective when assessing applications on this basis. As such, there is significant benefit to be found in the ability to use specific, fine-grained controls 245 and compliance evidence 275, and the ability to apply different mappings and weights may enhance the system's 230 ability to achieve the most fulsome assessment results. Conventional systems develop, implement and support several solutions which are siloed and specifically designed for assessing compliance with one regulatory policy, whereas some embodiments described herein allow greater flexibility to cater to the needs of any different corporate groups by re-using the same infrastructure. Moreover, some embodiments described herein allow different corporate groups to set their own goals 246 for classification and optimization of weights and mappings 620.

It will be readily appreciated that within a large organization, different teams may have different priorities and requirements, and may require the use of different sets of controls 245 and/or the assignment of different weights in accordance with those priorities and requirements. Advantageously, some embodiments described herein allow for each team to intuitively define their own customized mapping by focusing on controls 245 and documents 210. Since system 230 stores all different mappings 620 independently and with version control and identification, system 230 allows users to use multiple different assessments instead of only having one. Moreover, system 230 allows for combining these different approaches and results into an overall assessment.

In addition, system 230 can be configured to set up and test different experimental goals 246 and evaluate them with relatively minimal effort. Moreover, some embodiments may allow system 230 to perform automatic optimization from a set of heuristic and/or stochastic starting points. In this manner, system 230 may be used as a control to protect against or identify blind spots in compliance.

The following is a detailed example processing scenario which makes use of some of the principles and features described herein. The example scenario begins with a user request to determine compliance using a specific regulatory requirement document 212 which the user selected. However, it should be noted that a user can select more than one regulatory document 212 (in which case the same process would repeat in parallel). In some embodiments, a user may select a specific compliance schema (e.g. a set of one or more mapping 620 objects between the selected regulatory trees 505 and compliance controls 245 which will be used to calculate compliance scores to complete the assessment request).

In some embodiments, a compliance schema may additionally include an aggregation model for combining the results of compliance assessments using multiple mapping objects 620 to calculate overall compliance scores. An aggregation model may define a set of applications which may be used to filter the set of compliance evidence 275 used in order to reduce the amount of data to only the compliance evidence 275 which is relevant to that set of applications. In some embodiments, the aggregation model may be based on an organization structure (e.g. applications used by a particular business unit), application type (e.g. all applications of a certain type), or environment (e.g. all applications which run on a particular public cloud). In some embodiments, a system default configuration may be used if a compliance schema does not include an aggregation model. In some embodiments, a user may select between an aggregation model or the system default configuration.

Continuing with the example scenario, once the user has selected the complex input variables, system 230 will start by making a series of lookups and retrievals. For example, the system will retrieve the regulatory tree document 505 set and associate mappings 620 for each tree 505. In parallel, system 230 may create a plurality of lookups to create a filter for filtering out compliance evidence 275 relevant to the particular set of applications being assessed. Still in parallel, system 230 may process compliance evidence 275 for each mapping object 620 and apply the weights accordingly. The results may then be presented to the user on a user interface. In some embodiments, system 126 may allow for the customized selection of rules and filters, such as how old compliance evidence 275 is permitted to be, what to do when compliance evidence 275 is not available, and the like.

Some embodiments may implement a semantic naming schema configured to generate unique strings (thereby enabling greater system flexibility). FIG. 9 provides an example tree structure 505 having nodes which have been named using an example semantic naming schema. In some embodiments, a naming schema may be of the form: <regulator>:<regulatory-doc>:<version>:<date>. As depicted in FIG. 8, each node in example tree 505 is named in accordance with this example naming schema, followed by a unique number within the tree hierarchy of the form “<tree-uuid>: <node>”.

Thus, root node 605 is named “OSFI:B13:V01-JUN:2022:ROOT”. The nodes 610 in the first level down from root node are named: “OSFI:B13:V01-JUN:2022:ROOT.1”, “OSFI:B13:V01-JUN:2022:ROOT.2”, and “OSFI:B13:V01-JUN:2022:ROOT.3”. The nodes the second level down from the root node are named: “OSFI:B13:V01-JUN:2022:ROOT.1.1”, “OSFI:B13:V01-JUN:2022:ROOT.1.2”, “OSFI:B13:V01-JUN:2022:ROOT.2.1”. The nodes the third level down from the root node are named: “OSFI:B13:V01-JUN:2022:ROOT.1.1.1”, “OSFI:B13:V01-JUN:2022:ROOT.2.1.1”, “OSFI:B13:V01-JUN:2022:ROOT.2.1.2”, and so on.

In some embodiments, each compliance control object identifier is a unique identifier which possesses the quality of high collision resistance. An example control object identifier may include at least a name (e.g. “MIN.TLS.1.2”), description (e.g. “At a minimum TLS 1.2 is used”), data type (e.g. “Boolean”), and/or other optional attributes (e.g. details such as “TLS 1.2 is mandatory”). For example, an example compliance control object may be named: {“uuid”: “f615710b-e36b-4a64-bb99-7f0f43883c28”, “name”: “MIN.TLS.1.2”, “desc”: “At a minimum TLS 1.2 is used”, “type”: “bool”, “details”: “TLS 1.2 is mandatory”}.

In some embodiments, each mapping object identifier may include the regulatory document tree 505 name followed by the target object type and a short description and version. An example mapping object name might be: “OSFI:B13:V01-JUN:2022:CCM:7f0f43883c28”, where “CCM” means “Compliance Control Mapping”.

In some embodiments, the content of a mapping object 620 may require all leaf nodes 615a, 615b of a tree document 505 to be associated with an array (e.g. a list of compliance controls) as well as a weight for each control. An example mapping object 620 might be named:

“{″uuid″:″OSFI:B13:V01-JUN:2022:CCM:7f0f43883c28″, ″mappings″:[

{″node″: ″OSFI:B13:V01-JUN:2022:ROOT.2.1.1″, ″controls″: [

{″cc-uuid″:″e11c52f8-a7b6-4fa1-b306-dbbc459412c7″, ″weight″: ″0.3″},
{″uuid″:″ea7754af-10e4-4707-8963-e11dd0e93220″, ″weight″: ″0.2″},
{″uuid″:″f615710b-e36b-4a64-bb99-7f0f43883c28″, ″weight″: ″0.5″}]}]}

It will be appreciated that the above-noted example mapping 620 is between the leaf nodes 615 of a regulatory tree 505 and a compliance control set. However, other types of mappings 620 are contemplated.

For example, a mapping 620 may map compliance controls 245 to compliance evidence 275. Such an example mapping 620 may have the naming structure: {“uuid”:“ea7754af-10e4-4707-8963-e11dd0e93220:AWS:20230525”, “sources”: [

{″name″: ″https-only″, ″weight″: ″0.5″},
{″name″: ″tls-1.2″, ″weight″:″0.5″}]}

The above-noted mapping object name may be a universal unique identifier (UUID), and includes a compliance control UUID followed by an environment identifier (e.g. Amazon Web Services (AWS)), followed by a date (e.g. May 25 2023, or 20230525). In this example, the date attribute may provide a cutoff date for the processing of historical evidence.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method for monitoring compliance of a computing system, the method comprising:
receiving a plurality of documents containing rules;
converting each of said plurality of documents to a respective tree structure comprising a plurality of nodes;
generating a tree mapping relating a first one of said respective tree structures to a second one of said respective tree structures;
generating a control mapping relating said first one of said respective tree structures to a set of one or more compliance controls;
generating an evidence mapping relating said set of one or more compliance controls to a set of compliance control evidence; and
determining a compliance score for an entity based on said compliance controls, said compliance control evidence, and said evidence mapping.

2. The method of claim 1, wherein each of said mappings includes a set of weights.

3. The method of claim 1, wherein said set of controls is decoupled from said set of compliance control evidence by said evidence mapping.

4. The method of claim 1, wherein each of said plurality of nodes has a unique identifying string assigned thereto.

5. The method of claim 4, wherein said unique identifying string includes at least one of a name, a description, a data type, a version number, and/or a weight.

6. The method of claim 1, wherein each of said mappings is a tree structure comprising a set of weights.

7. A system for monitoring compliance of a computing system, the system comprising:
one or more processors; and
a non-transitory computer-readable storage medium having stored thereon processor-executable instructions that, when executed by said one or more processors, cause the one or more processors to perform a method comprising:
receiving a plurality of documents containing rules;
converting each of said plurality of documents to a respective tree structure comprising a plurality of nodes;
generating a tree mapping relating a first one of said respective tree structures to a second one of said respective tree structures;
generating a control mapping relating said first one of said tree structures to a set of one or more compliance controls;
generating an evidence mapping relating said set of one or more compliance controls to a set of compliance control evidence; and
determining a compliance score for an entity based on said compliance controls, said compliance control evidence, and said evidence mapping.

8. The system of claim 7, wherein each of said mappings includes a set of weights.

9. The system of claim 7, wherein said set of controls is decoupled from said set of compliance control evidence by said evidence mapping.

10. The system of claim 7, wherein each of said plurality of nodes has a unique identifying string assigned thereto.

11. The system of claim 10, wherein said unique identifying string includes at least one of a name, a description, a data type, a version number, and/or a weight.

12. The system of claim 7, wherein each of said mappings is a tree structure comprising a set of weights.

13. A non-transitory computer-readable storage medium having stored thereon processor executable instructions that, when executed by one or more processors, cause the one or more processors to perform a method comprising:
receiving a plurality of documents containing rules;
converting each of said plurality of documents to a respective tree structure comprising a plurality of nodes;
generating a tree mapping relating a first one of said respective tree structures to a second one of said respective tree structures;
generating a control mapping relating said first one of said respective tree structures to a set of one or more compliance controls;
generating an evidence mapping relating said set of one or more compliance controls to a set of compliance control evidence; and
determining a compliance score for an entity based on said compliance controls, said compliance control evidence, and said evidence mapping.

14. The computer-readable storage medium of claim 13, wherein each of said mappings includes a set of weights.

15. The computer-readable storage medium of claim 13, wherein said set of controls is decoupled from said set of compliance control evidence by said evidence mapping.

16. The computer-readable storage medium of claim 13, wherein each of said plurality of nodes has a unique identifying string assigned thereto.

17. The computer-readable storage medium of claim 16, wherein said unique identifying string includes at least one of a name, a description, a data type, a version number, and/or a weight.

18. The computer-readable storage medium of claim 13, wherein each of said mappings is a tree structure comprising a set of weights
